(19) United States
(12) Patent Application Publication
(10) Pub. No.: US 2016/0019685 A1
(43) Pub. Date: Jan. 21, 2016

(54) Method for Performing a Cosmetic Evaluation of a Used Electronic Device

(71) Applicant: Tu Nguyen, Fremont, CA (US)

(72) Inventor: Tu Nguyen, Fremont, CA (US)

(21) Appl. No.: 14/474,262

(22) Filed: Sep. 1, 2014

Related U.S. Application Data
(60) Provisional application No. 62/027,096, filed on Jul. 21, 2014.

(51) Int. Cl. G06T 7/00; G06K 9/52; G06K 9/62; G06T 11/60

(52) U.S. Cl. CPC G06T 7/0004; G06T 7/004; G06T 11/60; G06K 9/52; G06K 9/6267

(57) ABSTRACT

A system and method for cosmetic evaluation of an electronic device, using the device's own camera or cameras to take photos of the device itself using a mirror or mirrors.

### CROSS-REFERENCE TO RELATED APPLICATIONS

The present application takes priority from Provisional App. No. 62/027,096, filed Jul. 21, 2014, which is herein incorporated by reference.

### BACKGROUND

Smartphones and other small electronic devices evolve rapidly, and thus are frequently upgraded by consumers. As a result, many consumers have one or more used electronic devices that they no longer need. Reselling those devices is often a hassle that does not justify the time or the expense of doing so.

In order to determine the value of a used electronic device, its functional capacity and its cosmetic condition need to be evaluated. While evaluating a device's functional capacity usually only requires some simple electronics, evaluating the device's cosmetic condition requires either a human eye (and humans are often biased and inconsistent) or expensive and complex camera systems. In situations where a used electronic device is being repurchased automatically, at a kiosk, for example, the only option being used at present is expensive and complex camera systems.

Camera systems are expensive; the other drawback they have is that they are not available to the consumer at their home. In some cases, a consumer would want to evaluate the functional and cosmetic condition of their device at home, as part of determining the potential resale value of their device before traveling to a kiosk or a resale center. It is relatively simple to install an app on the device to evaluate its functional condition; however, a consumer is unlikely to have a camera system at their home for the cosmetic evaluation.

A need therefore exists for a simpler way to perform a cosmetic evaluation of an electronic device that does not require an expensive camera system.

### SUMMARY OF THE INVENTION

An object of the present invention is to provide a method for performing a cosmetic evaluation of an electronic device using the device's own built-in camera rather than an external camera system (which is expensive and complex).

Another object of the present invention is to provide a method for performing a cosmetic evaluation of an electronic device that can be performed at home by a consumer.

Another object of the present invention is to provide a method for performing a cosmetic evaluation of an electronic device that uses the electronic device's own camera or cameras to take reference photos.

In an embodiment, the method of the present invention comprises positioning a mirror in front of an electronic device in such a way that at least one camera of the electronic device faces the mirror, and using the camera to take a photograph of the electronic device. The photograph is then analyzed to determine how many cracks, scratches, and other imperfections exist on the electronic device.

Some electronic devices have one front-facing camera and one rear-facing camera. In an embodiment, the method of the present invention comprises positioning a mirror in front of an electronic device in such a way that the front-facing camera faces the mirror and using the front-facing camera to take a photograph of the front side of the electronic device; then positioning the mirror (or the electronic device) in such a way that the rear-facing camera faces the mirror and using the rear-facing camera to take a photograph of the rear side of the electronic device. Then, both photographs are analyzed to determine how many cracks, scratches, and other imperfections exist on the electronic device.

In an embodiment, a second mirror is positioned in such a way as to reflect at least one of the sides of the device in a way that either the front-facing or the rear-facing camera can take a photograph of at least one of the sides of the device. Then, that photograph is analyzed to determine how many cracks, scratches, and other imperfections exist on the electronic device. In an embodiment, at least one of the photographs taken this way shows a water damage indicator on the electronic device.

In an embodiment, the screen of the electronic device is prevented from showing an image of what is “seen” by the camera. Instead, it can show another image or a solid color, said image or solid color being intended to show any scratches, cracks, or other imperfections on the screen on the device more clearly than the image of what's in front of the camera.

The analysis step preferably comprises changing at least one visual parameter of the photograph to make any imperfections more visible, counting the number of imperfections in the photograph and determining the length of each imperfection, and using this information to produce a cosmetic condition score. In an embodiment, different weighting can be ascribed to cracks, scratches, and wear marks. In another embodiment, different weighting can be ascribed to imperfections on the sides of the device versus imperfections on the screen of the device.

In an embodiment, the method of the present invention comprises a series of steps to determine whether a crack on the screen of the device affects the LCD screen, or whether it is a superficial crack that only affects the glass cover. If a crack on the screen of the device affects the LCD screen, the solid color or static image background will show some imperfections, either around the area of the crack, or elsewhere, due to the leakage of the liquid crystals. If the crack is superficial, the LCD screen will show no imperfections.

In an embodiment, the user is instructed on how to place the mirror or mirrors properly, or how to place the device in front of the mirror or mirrors, in order to take the pictures correctly. The instructions can be given visually (i.e. by images shown on the screen of the device), auditorially (via the speaker or earphone of the device), or by vibration (i.e. the device vibrates when it is placed correctly), or in any combination of these.

In an embodiment, the photograph or photographs are taken automatically when the device is at a particular distance from the mirror or mirrors. The distance is preferably the closest focal distance from the camera that is taking the photograph.

The method of the present invention can be practiced by an app installed on the electronic device itself, or by an automated kiosk for recycling and repurchasing electronic devices. If the method is practiced by a kiosk, the kiosk comprises hardware and software that automatically places the mirror or mirrors around the device in the correct position and automatically triggers the camera or cameras to take the photographs needed.

### LIST OF FIGURES

FIG. 1 shows a diagram of an electronic device being used to practice the method of the preferred embodiment of the present invention.

FIG. 2A shows the recursive images seen when taking a photo of an electronic device with a front-facing camera.

FIG. 2B shows a photo of an electronic device being taken with a front-facing camera with the screen disabled.

FIG. 3 shows an example of mirror placement for taking a photo of the sides of the electronic device.

FIG. 4 shows an example of a device photo, modified to make cosmetic imperfections more visible.

FIG. 5 shows a device enabling an automated kiosk to practice the method of the present invention.

### DETAILED DESCRIPTION OF THE PREFERRED EMBODIMENT

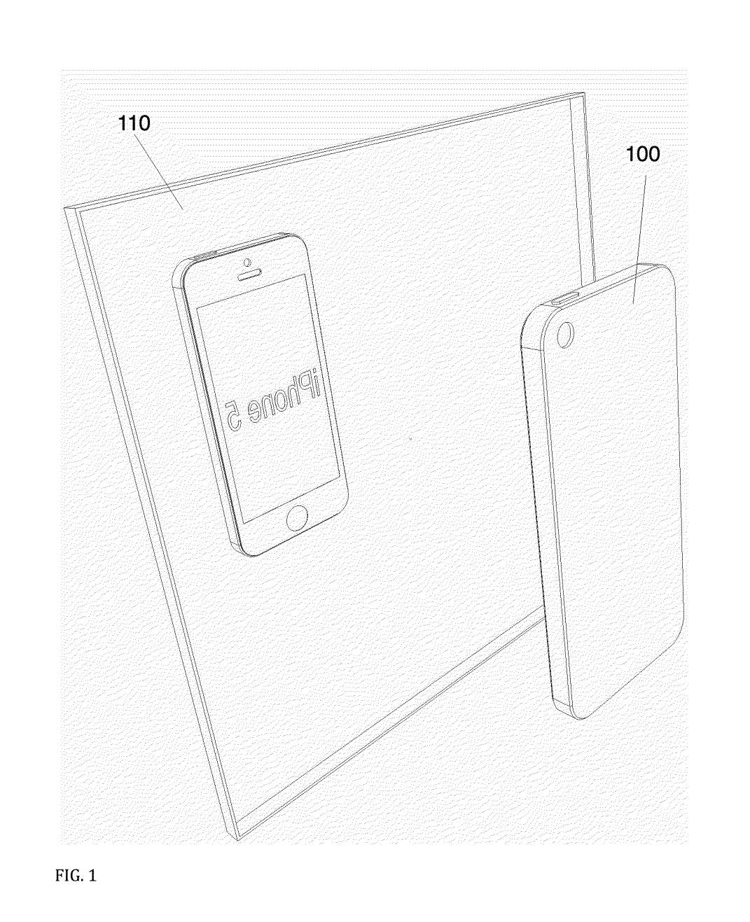

FIG. 1 shows a diagram of an electronic device 100 being used in front of a mirror 110 to take a picture of itself. The camera of the electronic device 120 is triggered either manually or automatically when the electronic device 100 is placed in front of the mirror 110. In the preferred embodiment, the electronic device 100 comprises an app that instructs the user on proper mirror placement and automatically takes a photo or photos when the electronic device and mirror are in correct relative positions. In an embodiment, a smaller mirror is used and the mirror is moved into position while the electronic device remains stationary.

In the preferred embodiment, the app performs at least the following functions: instructing the user on correct positioning of the electronic device in front of the mirror (or the mirror in front of the electronic device), taking the photo or photos (either automatically or manually) when the electronic device is correctly positioned, and analyzing the photo or photos for cracks, scratches, or other imperfections.

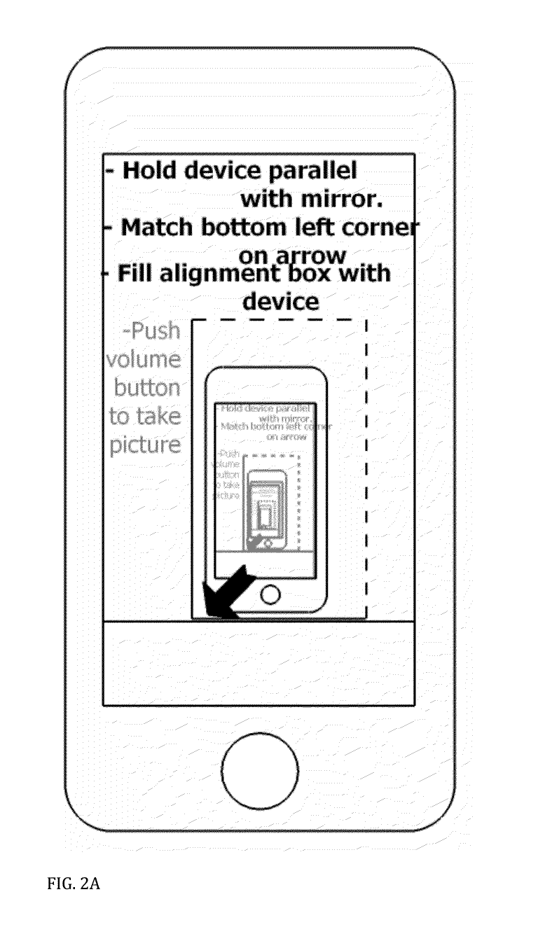

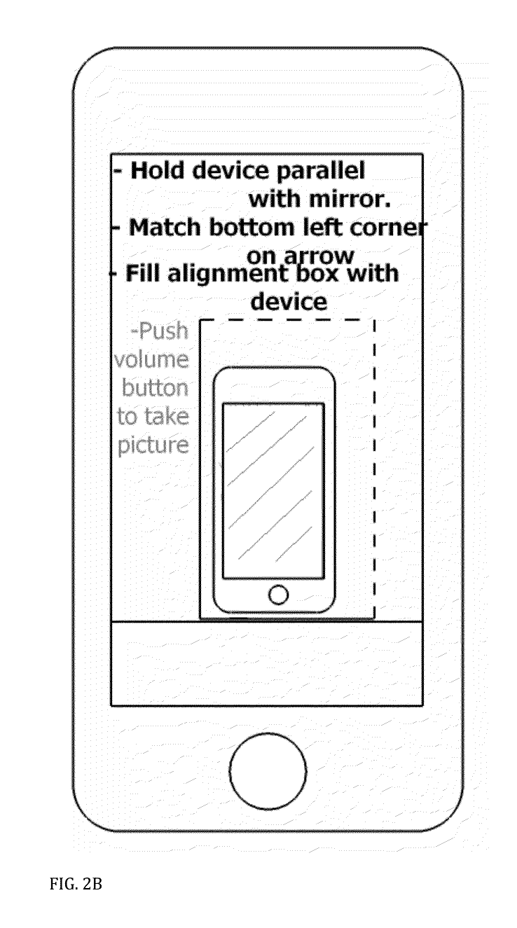

Typically, when a front-facing camera of a device is used to take a photo, the screen of the device shows what the camera is “seeing”. This causes trouble when the front-facing camera is used to take a photo of the electronic device itself in a mirror; FIG. 2A shows what happens when the screen of the device is allowed to show what the camera is “seeing” in that scenario. The recursive image shown in FIG. 2A can obscure any imperfections in the device screen and make it harder to analyze the photo to determine the condition of the device screen. Thus, the preferred embodiment disables this function of the screen when the front-facing camera is used to take a photo of the electronic device. FIG. 2B shows the front-facing camera of the device used to take a photo of the device with the screen disabled and showing a static image.

When the screen is disabled, it could simply be left turned off, or could show a solid color or a static image. Preferably, the screen shows a solid white background, which could easily show any cracks or other cosmetic imperfections in the glass or any imperfections in the LCD itself. However, any other image could be used. For example, the screen could show a grid so that any imperfections in the LCD screen could show up as distortions of the gridlines.

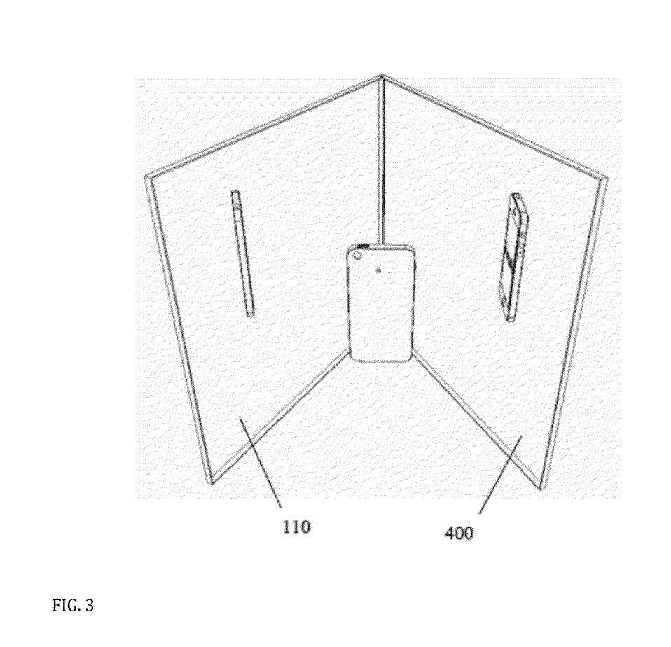

In an embodiment, the system and method of the present invention can also take photos of the sides of the electronic device. To do that, the user is instructed to place a second mirror 400 next to the device as shown in FIG. 3. The second mirror 400 reflects the sides of the device in a way that is visible to the front-facing camera. The front-facing camera is then used to take the photo. Alternately, the rear-facing camera or any other camera of the device could be used as well.

In an embodiment, the app also steganographically encodes data about the device in the device photo or photos. Such data may include the device ID or serial number, the name and address of the owner of the device, the date and time of the photo, some parameter of the photo itself (i.e. the number of blue pixels in the photo), and so on. This helps ensure that the photos of the device are authentic and not falsified by an unscrupulous user.

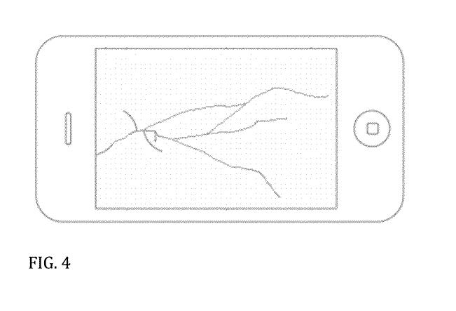

After the photos are taken, they are analyzed. This step can be performed either on the device itself or on a server to which the photos are uploaded. In the preferred embodiment, the photos are modified to increase the contrast level or any other visual parameter that makes imperfections more visible. FIG. 4 shows a device photo modified to increase the contrast level to make scratches more visible.

In the preferred embodiment, the photos are then compared to reference photos of an undamaged device of the same type. The markings on the photo that do not exist in the reference photo are counted and their length is measured. In an embodiment, the markings are also categorized into different categories such as “cracks”, “scratches”, “scuffs”, and so on.

A cosmetic score is then calculated for the device using the number of markings and their length, in each category. Any commonly-known method of calculating a score can be used. For example, the markings can be divided into categories by length—scratches less than 1 mm in length, scratches between 1 mm and 2 mm in length, and so on. Then, the number of scratches in each category is multiplied by the average length of the scratches in that category, and the products for each category are added together. The result would be the “scratch score”. A “crack score” and a “scuff score” could be calculated similarly, and the three numbers could be added together, or multiplied by different weighting factors before being added together (since cracks are more serious than scuffs, the “crack score” could be multiplied by a weighting factor higher than 1, for example).

While a preferred embodiment of calculating the cosmetic score is described above, any other method of calculating a score based on the cosmetic data could be used.

In an embodiment, the analysis method could distinguish between cracks that only superficially affect the glass cover of the LCD screen of a device, and cracks that affect the LCD screen itself. For that embodiment, the LCD screen is set to display a solid color background (preferably white) for the photo of the front of the device. In that embodiment, the presence of any cracks on the front side of the device leads to a further analysis step. The further analysis step changes the visual parameters of the photo until the glowing device screen is visually distinct from the rest of the device. The image of the glowing screen is then analyzed for any inconsistencies or imperfections. If any imperfections are present, the LCD screen is assumed to be damaged. If the glowing screen is free of imperfections, the LCD screen is assumed to be undamaged. The “crack score” of the device can then be calculated accordingly—cracks that only affect the glass cover can be weighted less heavily than cracks that affect the LCD screen.

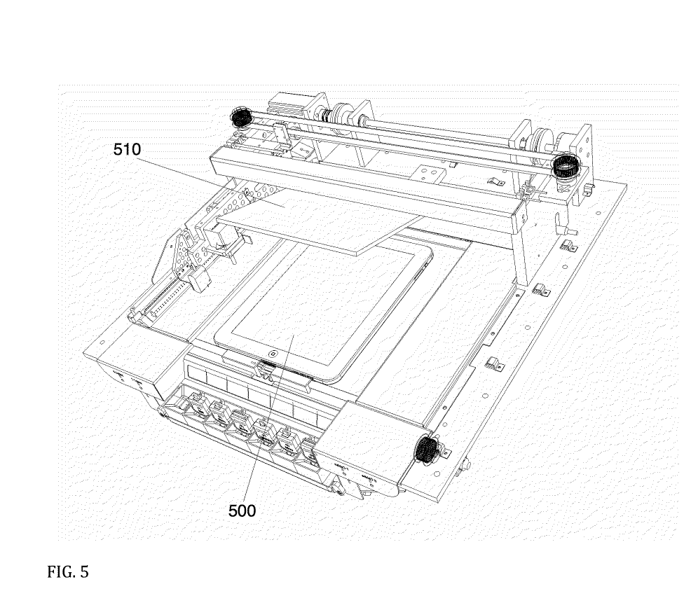

The method of the present invention can be practiced manually by a user, as directed by the app (i.e. having the user manipulate the device, a mirror or mirrors, and take the photos), or automatically by a kiosk or other device. If the method is practiced automatically by a kiosk or another device, it automatically places the mirrors in the correct positions for taking the photos required for the analysis. An embodiment of the invention using a kiosk is pictured in FIG. 5. Mirror 510 is moved automatically to reflect an image of an electronic device 500 in such a way that the camera of the electronic device can be triggered to take pictures of the device itself.

Exemplary embodiments have been described above. It will be understood that the invention encompasses other embodiments and that the only limitations on the scope of the present invention are expressed in the appended claims.

1. A method of performing a cosmetic evaluation of an electronic device, said electronic device having a front side, back side, top side, bottom side, right side, and left side, said electronic device having a first camera located on the back side, said method comprising:
positioning a mirror in front of the first camera;
using the first camera to take a first photograph of the back side of the electronic device;
analyzing the first photograph to determine the cosmetic condition of the electronic device.

2. The method of claim 1, where the electronic device further comprises a second camera located on the front side, further comprising:
positioning a mirror in front of the second camera;
using the second camera to take a second photograph of the front side of the electronic device;
analyzing the second photograph to determine the cosmetic condition of the electronic device.

3. The method of claim 1, further comprising:
positioning a second mirror near the device in such a way that at least one of the top side, bottom side, right side, and left side, are reflected in such a way that at least one of the first camera and second camera can photograph the at least one of the top side, bottom side, right side, and left side, resulting in at least one additional photograph;
analyzing the at least one additional photograph to determine the cosmetic condition of the device.

4. The method of claim 2, further comprising:
disabling the screen of the electronic device while the second photograph is taken.

5. The method of claim 4, wherein the screen of the electronic device is set to display a static image while the second photograph is taken.

6. The method of claim 5, wherein the static image is a solid color.

7. The method of claim 1, wherein the analyzing step is performed by:
changing the contrast on the photograph to make any imperfections more visible;
counting the number of scratches and wear marks in the photograph and determining the length of each imperfection;
using the number of scratches and wear marks and their length to produce a cosmetic condition score.

8. The method of claim 7, wherein the analyzing step comprises:
determining whether the second photograph shows any cracks in the screen of the device;
if the second photograph shows a crack on the screen of the device, determining whether the solid white background shows any imperfections around the area of the crack;
if the solid white background shows any imperfections around the area of the crack, concluding that the LCD screen of the device is damaged;
if the solid white background shows no imperfections around the area of the crack, concluding that the LCD screen of the device is undamaged.

9. The method of claim 3, where at least one additional photograph shows a water damage indicator on the electronic device.

10. The method of claim 1, where the electronic device displays instructions for a user for the step of placing a mirror in front of the first camera.

11. The method of claim 2, where the electronic device displays instructions for a user for the step of placing a mirror in front of the second camera.

12. The method of claim 9, where the instructions are one or more of the following: auditory, visual, vibratory.

13. The method of claim 1, where the electronic device is triggered to take the first photograph automatically when it is at a predetermined distance from the mirror, said predetermined distance being the closest focal distance for the first camera.

14. The method of claim 1, further comprising:
determining the device ID;
steganographically encoding at least one of the following: the device ID, a time and date of the photograph, a visual parameter of the photograph, or the name of the owner of the electronic device, in the photograph.

15. A kiosk for recycling electronics, said kiosk comprising hardware and software that enables said kiosk to perform the method of claim 1.
